(19) United States
(12) Patent Application Publication
(10) Pub. No.: US 2010/0253580 A1
(43) Pub. Date: Oct. 7, 2010

(54) PRINTED ANTENNA AND ELECTRONIC DEVICE EMPLOYING THE SAME

(75) Inventors: Tao YAN, Shenzhen City (CN); Dong WEI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Tu-Cheng (CN); HON HAI PRECISION INDUSTRY CO., LTD., Tu-Cheng (TW)

(21) Appl. No.: 12/430,109

(22) Filed: Apr. 27, 2009

(30) Foreign Application Priority Data
Apr. 2, 2009 (CN) 200920301870.7

(51) Int. Cl. H01Q 1/38

(52) U.S. Cl. 343/700 MS

(57) ABSTRACT

A printed antenna includes a feeding portion, a radiating portion, a grounding portion, and a short portion. The feeding portion is operable to feed electromagnetic signals. The radiating portion is connected to the feeding portion, to radiate the electromagnetic signals. The radiating portion includes a first radiator and a second radiator. The first radiator is “L” shape, with a first end electrically connected to the feeding portion. The second radiator is formed by a plurality of radiating sections connected one by one. A first end of the second radiator is connected to a second end of the first radiator, a second end of the second radiator is floating and facing the feeding portion. A first end of the short portion is connected to a common node of the first radiator and the second radiator, and a second end of the short portion is connected to the grounding portion.

### BACKGROUND

1. Technical Field

Embodiments of the present disclosure relate to antennas, and more particularly to a printed antenna.

2. Description of Related Art

In order to make them more convenient, wireless communication devices are generally built small. As antennas are necessary components in the wireless communication devices for tranceiving electromagnetic signals, one solution for maintaining the reduced dimensions is to reduce the dimensions of the antennas. Printed antennas in current use are often rectangular, round, or annular, and though small, a demand remains for them to be made even smaller while still providing the desired frequency coverage.

### BRIEF DESCRIPTION OF THE DRAWINGS

Many aspects of the embodiments can be better understood with references to the following drawings.

FIG. 1 is a schematic diagram of an electronic device comprising a printed antenna according to the present disclosure;

FIG. 2 illustrates an exemplary embodiment of the printed antenna of FIG. 1 illustrating exemplary expanding dimensions;

FIG. 3 is a graph showing an exemplary return loss of the print antenna of FIG. 1 operating at frequency bands of 2.4 GHz and 2.5 GHz;

FIG. 4 is a gain simulation graph of the printed antenna of FIG. 1; and

FIG. 5 is an efficiency simulation graph of the printed antenna of FIG. 1.

### DETAILED DESCRIPTION

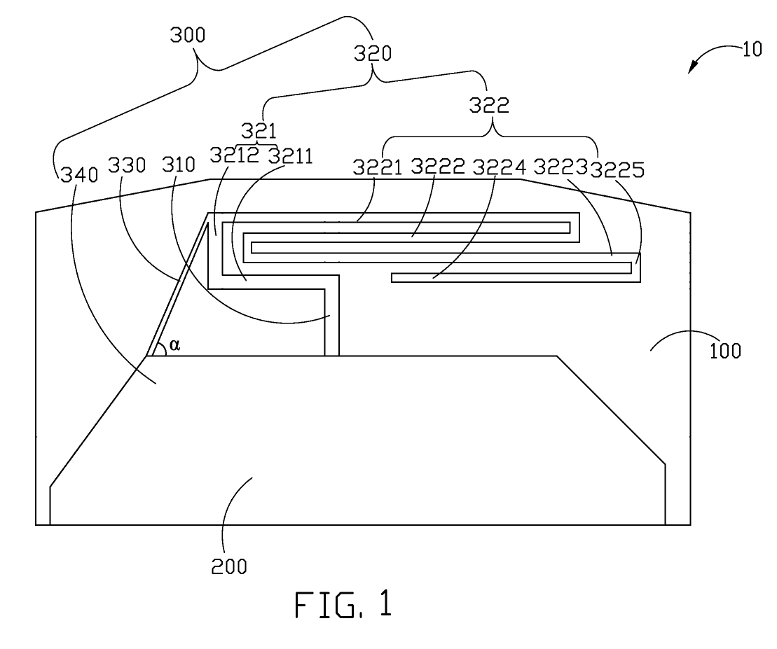

Referring to FIG. 1, a schematic diagram shows an electronic device 10 as disclosed, comprising a substrate 100, a printed antenna 300, and a shielding portion 200. The printed antenna 300 is positioned on the substrate 100 and comprises a feeding portion 310, a radiating portion 320, a short portion 330, and a grounding portion 340. In one embodiment, the printed antenna 300 and the shielding portion 200 cooperatively form an integral piece.

In one embodiment, the substrate 100 is a printed circuit board (PCB). The printed antenna 300 is a planar inverted F antenna (PIFA), formed by the foil of the PCB.

The shielding portion 200 is positioned on the grounding portion 340, for impedance matching with the antenna 300, therefore, reducing the space and cost of the electronic device 10. In one embodiment, the grounding portion 340 and the shielding portion 200 are both trapezoidal in shape and overlap each other.

The feeding portion 310 is elongate and feeds electromagnetic signals.

The radiating portion 320 is electrically connected to the feeding portion 310, operable to radiate electromagnetic signals. The radiating portion 320 comprises a first radiator 321 and a second radiator 322. The width of the first radiator 321 is different from that of the second radiator 322. In the illustrated embodiment, the width of the first radiator is wider than the width of the second radiator. However, in other embodiments, the width of the first radiator may be narrower than the width of the second radiator.

The first radiator 321 is substantially L-shaped, and electrically connected to the feeding portion 310. The first radiator 321 comprises a horizontal radiating section 3211 and a vertical radiating section 3212. The horizontal radiating section 3211 is perpendicularly connected to the feeding portion 310.

The second radiator 322 is formed by a plurality of radiating sections connected one by one. A first end of the second radiator 322 is electrically connected to the vertical radiating section 3212 of the first radiator 321, and a second end 3224 of the second radiator 322 is left floating. In the illustrated embodiment, the second end 3224 faces the feeding portion 310, and specifically a common node of the first radiator 321 and the feeding portion 310. The plurality of the radiating sections of the second radiator 322 comprise one or more elongated, L-shaped, and n-shaped radiating sections, for forming the second radiator 322 as substantially m-shaped.

For example, the second radiator 322 can comprise a first elongated radiating section 3221, a second elongated radiating section 3222, a third elongated radiating section 3223, and a free end 3224, parallel and connected by three connecting sections 3225. Alternatively, the second radiator 322 comprises a first L-shaped radiating section 3221, a second L-shaped radiating section 3222, a third L-shaped radiating section 3223, and a free end 3224. Alternatively, the second radiator 322 can comprise a first n-shaped radiating section 3221 and a second n-shaped radiating section 3222. The second n-shaped radiating section 3222 comprises a free end 3224.

In one embodiment, the free end 3224 of the second radiator 322 and the vertical radiating section 3212 of the first radiator 321 are substantially aligned and perpendicular to the feeding portion 310.

In one embodiment, the radiating portion 320 is bent towards the shielding portion 200. The radiation portion 320 and the shielding portion 200 cooperatively increase capacitive compensation effects of the antenna 300.

A first end of the short portion 330 is electrically connected to a common node of the first radiator 321 and the second radiator 322, and a second end of the short portion 330 is electrically connected to the shielding portion 200. Therefore, it is not necessary for the electronic device 10 to provide an extra matching circuit.

In one embodiment, an acute angle α is formed between the short portion 330 and the shielding portion 200 to reduce the area of the printed antenna 300. In addition, the short portion 330 is straight, and accordingly the short portion 330 and the shielding portion 200 increase inductive compensation effects of the antenna 300.

In one embodiment, the radiating portion 320 defines a plurality of slots, so as to increase coupling effects of the radiating portion 320.

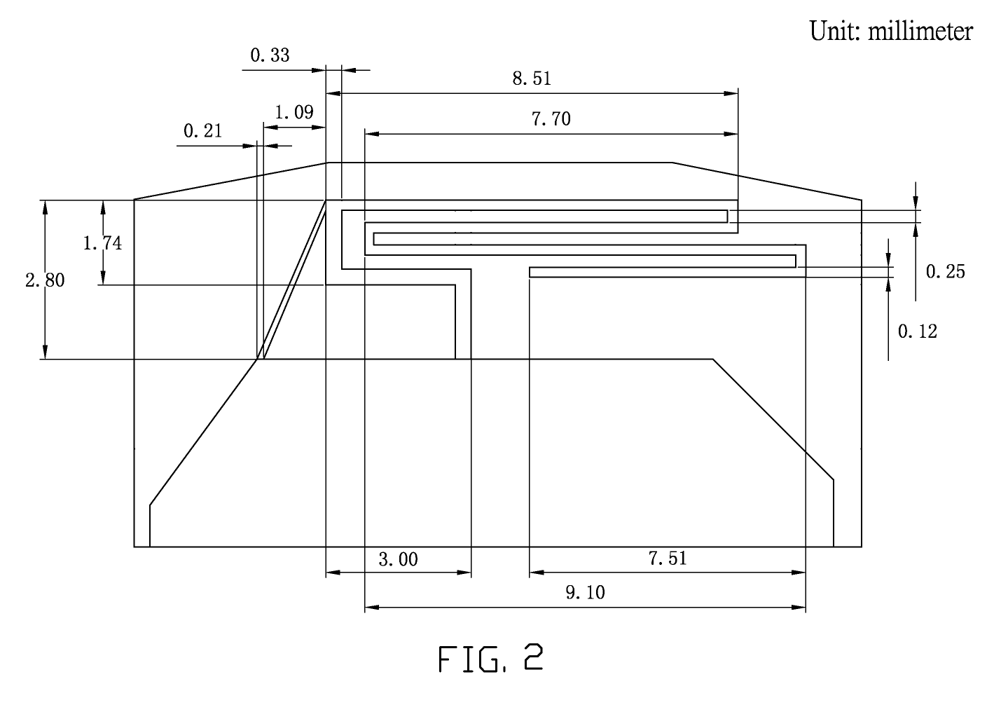

FIG. 2 illustrates an exemplary embodiment of the printed antenna 300 of FIG. 1 illustrating exemplary expanding dimensions. In one embodiment, the width of the first radiator 321 is 0.33 mm, the length of the horizontal radiating section 3211 is 3.00 mm, and the length of the vertical radiating section 3212 is 1.74 mm. The width of the second radiator 322 is 0.12 mm, the length of the first elongated radiating section 3221 is 8.51 mm, the length of the second elongated radiating section 3222 is 7.70 mm, the length of the third elongated radiating section 3223 is 9.10 mm, the length of the free end 3224 is 7.51 mm, and the three connecting section 32245 are 0.25 mm. The length of the point of the short portion 330 common node with the shielding portion 200 is 0.21 mm.

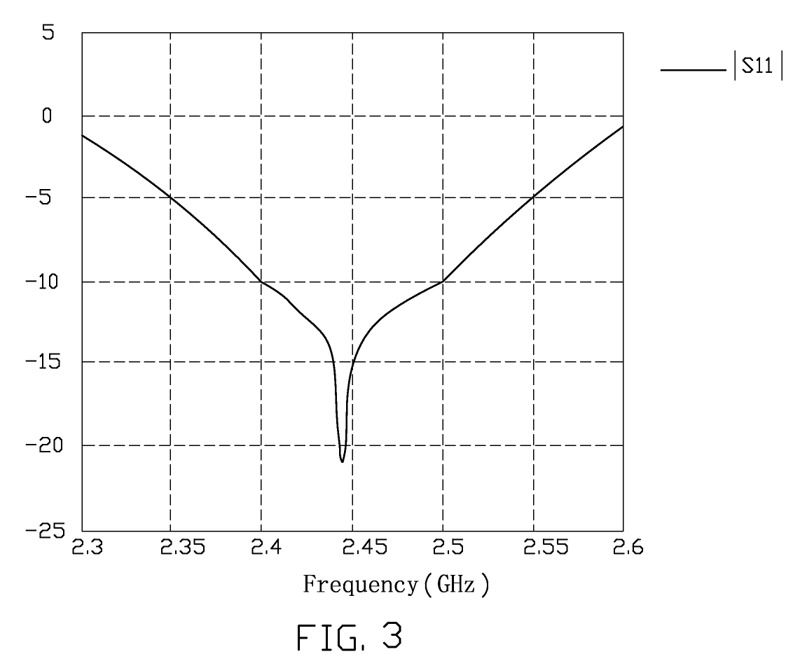

FIG. 3 is a graph showing one exemplary return loss of the print antenna 300 of FIG. 1 operating at the frequency bands of 2.4 GHz and 2.5 GHz. As shown, the attenuation amplitude is less than −10 dB, when the printed antenna 300 operates in frequency bands ranging from the 2.4 GHz to 2.5 GHz of the BLUETOOTH and WI-FI operation.

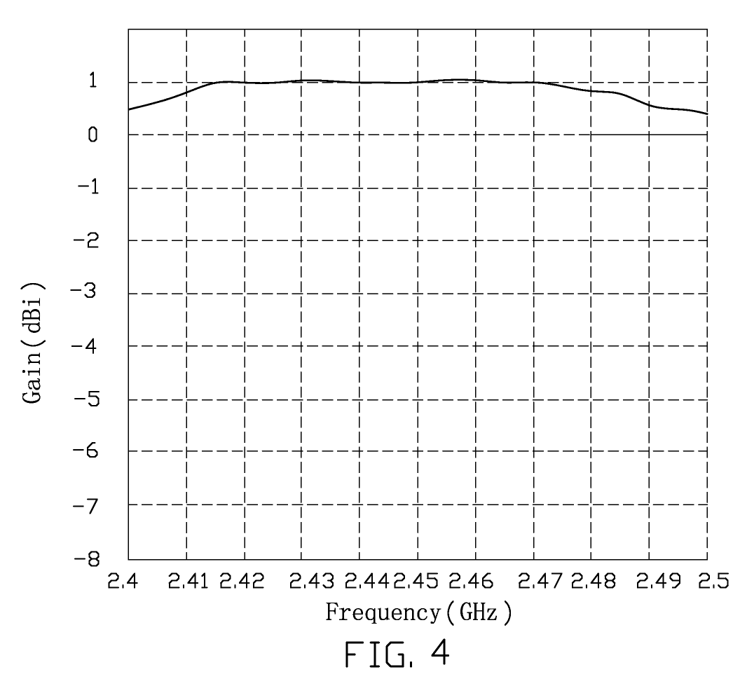

As shown in FIG. 4, when the printed antenna 300 operates in the frequency bands of 2.3 GHz to 2.5 GHz of BLUETOOTH and WI-FI, the gain is smooth, and near 1 dBi. Thus, the printed antenna 300 has good performance.

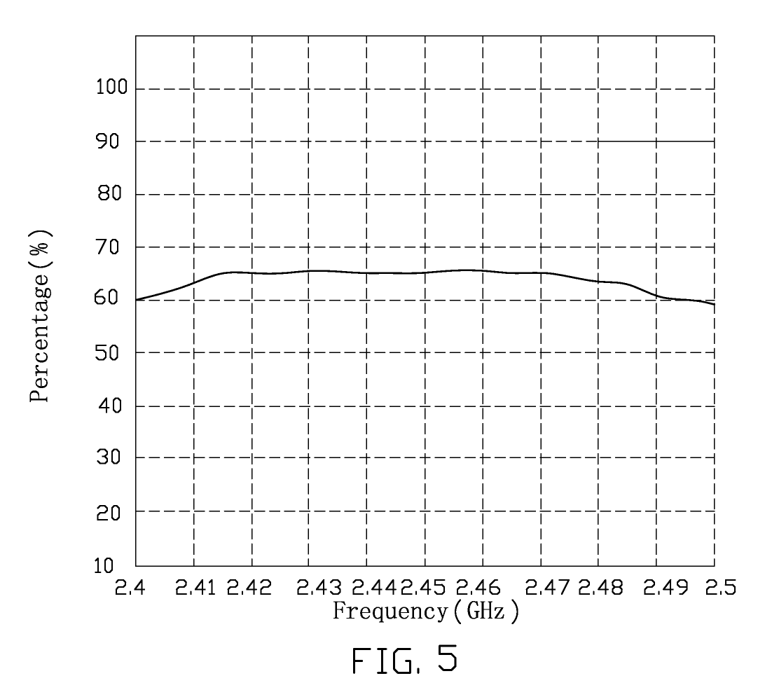

FIG. 5 is an efficiency simulation graph of the printed antenna 300 of FIG. 1. When the printed antenna operates in the frequency bands of 2.3 GHz to 2.5 GHz, the efficiency is more than 60%, with good performance.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A printed antenna, positioned on a substrate, comprising:
a feeding portion operable to feed electromagnetic signals;
a radiating portion electrically connected to the feeding portion, operable to radiate the electromagnetic signals, the radiating portion comprising:
a first radiator with an “L” shape, a first end of the first radiator being electrically connected to the feeding portion; and
a second radiator formed by a plurality of radiating sections connected one by one, wherein a first end of the second radiator is connected to a second end of the first radiator, and wherein a second end of the second radiator is floating and facing the feeding portion;
a grounding portion positioned on the substrate; and
a short portion with a first end connected to a common node of the first radiator and the second radiator, and a second end connected to the grounding portion.

2. The printed antenna as claimed in claim 1, wherein the grounding portion is positioned on a shielding portion.

3. The printed antenna as claimed in claim 2, wherein the grounding portion is trapezoidal.

4. The printed antenna as claimed in claim 3, wherein the short portion and the shielding portion cooperatively increase inductive compensation effects of the antenna.

5. The printed antenna as claimed in claim 4, wherein the second radiator and the shielding portion cooperatively increase capacitive compensation effects of the antenna.

6. The printed antenna as claimed in claim 5, wherein the plurality of radiation sections of the second radiator comprises one or more elongated, L-shaped, and n-shaped radiating sections.

7. The printed antenna as claimed in claim 6, wherein the second radiator is substantially asymmetrically M-shaped.

8. The printed antenna as claimed in claim 7, wherein the second end of the second radiator faces a common node of the first radiator and the feeding portion.

9. An electronic device, comprising a substrate and a printed antenna positioned on the substrate operable to radiate electromagnetic signals, wherein the printed antenna comprises:
a feeding portion operable to feed electromagnetic signals;
a first radiator with an “L” shape, a first end of the first radiator being electrically connected to the feeding portion;
a second radiator formed by a plurality of radiating sections connected one by one, wherein a first end of the second radiator is electrically connected to a second end of the first radiator, and wherein a second end of the second radiator is floating and facing the feeding portion; and
a short portion with a first end connected to a common node of the first radiator and the second radiator, and a second end being electrically connected to the shielding portion.

10. The electronic device as claimed in claim 9, further comprising a shielding portion positioned on the substrate.

11. The electronic device as claimed in claim 9, wherein the printed antenna and the shielding portion cooperatively form an integral piece.

12. The electronic device as claimed in claim 9, wherein the grounding portion is trapezoidal.

13. The electronic device as claimed in claim 9, wherein the short portion and the shielding portion cooperatively increase inductive compensation effects of the antenna.

14. The electronic device as claimed in claim 13, wherein the second radiator and the shielding portion cooperatively increase capacitive compensation effects of the antenna.

15. The electronic device as claimed in claim 9, wherein the plurality of radiation sections of the second radiator comprise one or more elongated, L-shaped, and n-shaped radiation sections.

16. The electronic device as claimed in claim 13, wherein the second radiator is substantially asymmetrically M-shaped.

17. The electronic device as claimed in claim 14, wherein the second end of the second radiator faces a common node of the first radiator and the feeding portion.
